(19) United States
(12) Patent Application Publication
(10) Pub. No.: US 2017/0112590 A1
(43) Pub. Date: Apr. 27, 2017

(54) APPARATUS AND METHOD FOR POWER ACTIVATION OF MEDICAL INSTRUMENTS

(71) Applicants: Erik Brown, Monrovia, CA (US); Brenton C. Lively, Orange, CA (US); Steve Jones, Orange, CA (US)

(72) Inventors: Erik Brown, Monrovia, CA (US); Brenton C. Lively, Orange, CA (US); Steve Jones, Orange, CA (US)

(21) Appl. No.: 15/331,483

(22) Filed: Oct. 21, 2016

Related U.S. Application Data
(60) Provisional application No. 62/244,364, filed on Oct. 21, 2015.

(51) Int. Cl. A61C 1/00; A61C 5/02

(52) U.S. Cl. CPC A61C 1/0015; A61C 5/02

(57) ABSTRACT

Method and apparatuses for powering medical devices on and off. One embodiment provides an apparatus that includes a plurality of medical devices. Each of the plurality of medical devices is configured to be electrically activated and deactivated. A central unit is configured to communicate with each of the plurality of medical devices and to receive a signal indicative of a triggering event. In response to receiving a signal that a first triggering event has occurred, the central unit sends each of the plurality of medical devices a signal to activate at the same time.

### TECHNICAL FIELD

The present invention relates generally to dental procedures, and more particularly to apparatuses and methods for activating and/or deactivating a plurality of medical devices used in a dental procedure, such as an endodontic procedure.

### BACKGROUND

Dental procedures, especially endodontic procedures, are often lengthy and involve multiple steps that require a variety of small electrical devices. By way of example, root canal therapy may be completed in essentially a three step process using multiple electronic devices. First, a dentist, endodontist, or other medical practitioner mechanically removes infected pulp from within the internal root structure of a tooth. In this regard, the clinician may use an electronic pulp vitality scanner to assess the state of the pulp tissue within the root canal prior to removal. Furthermore, an electronic apex locator may be used to identify the length of the root canal and to ensure that the pulp tissue has been removed all the way to the apex of the canal. Moreover, the clinician may use an electronic motor to drive endodontic files that shape the canal. Second, the internal root structure is cleaned and disinfected leaving a void in the place of the infected pulp. This step may involve the use of an electronic ultrasonic device to clean and further shape the canal. Third, the void is obturated or filled with a biocompatible, semi-structural material, such as Gutta Percha. Devices used during this process can be, for example, an electronic downpack device to heat and condense the material in the apical portions of the canal and an electronic backfill device to fill the proximal regions of the tooth. As a result, endodontic procedures can be lengthy, and, accordingly, clinicians are eager to save time wherever possible.

During certain dental procedures, such as that described above, clinicians must repeat the task of turning on and off each of the devices individually throughout the procedure. Previously, corded devices could be activated simultaneously by plugging them into a single power strip and turning on the power strip so as to turn on all of the devices electronically coupled to the power strip. However, some devices do not turn on simply because they are electrically connected. Moreover, with the rise of the use of cordless devices, simply turning on a power strip is unlikely to activate all the devices. In many cases, the devices needed for endodontic procedures are equipped with a dedicated power switch that needs to be individually turned on by the user to activate the device. Cordless devices may be connected to electricity, for example, when positioned on a base while the device is charging (e.g., in a cradle charging station), but are not activated until the power switch is pressed. Clinicians must spend time that could otherwise be used more efficiently making sure the necessary devices are turned on and off. Additionally, some devices, for example the backfill device, require a certain amount of time to warm-up before they are fully operational for their intended use in the procedure. Forgetting to turn on a device that must warm up beforehand can further increase the length of a procedure. A longer procedure results in decreased efficiency for the clinician and a longer time the patient must be in the chair.

There is a need for an apparatus and method for use in endodontic procedures, such as root canal therapy, that addresses present challenges and drawbacks such as those discussed above.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is a perspective view of an embodiment of the present invention where two devices are received on a central unit that has a button.

FIG. 1A is a graphical view depicting the embodiment illustrated in FIG. 1 where a central unit is in communication with two devices.

FIG. 1B is a flowchart of a communication between the central unit and one of the devices illustrated in FIG. 1.

FIG. 1C is a flowchart of communications between the central unit and two devices illustrated in FIG. 1.

FIG. 2 is a graphical view of an embodiment of the present invention depicting a central unit in communication with three devices.

FIG. 2A is a flowchart of communications between the central unit and two of the devices depicted in FIG. 2.

FIG. 3 is a graphical view of an embodiment of the present invention depicting four devices in communication with at least one other device.

FIG. 3A is a flowchart of a communication between two of the devices depicted in FIG. 3.

FIG. 4 is a graphical view of an embodiment of the present invention depicting four devices where each device is in communication with at least two other devices.

FIG. 4A is a flowchart of communications between three of the devices depicted in FIG. 4.

FIG. 5 is a graphical view of an embodiment of the present invention depicting a central unit in communication with three devices where each device is also in communication with at least one other device.

FIG. 5A is a flowchart of communications between two of the devices and the central unit depicted in FIG. 5.

FIG. 5B is an elevation view of the embodiment depicted in FIG. 5 where a central unit is indicating the status of three devices.

FIG. 6 is a flowchart of a triggering event that results in a triggering event schedule being overridden in an embodiment of the present invention.

### DETAILED DESCRIPTION

The present invention includes apparatuses and methods involving powered devices used in dental procedures. For example, devices may include, but not limited to, a scanner, apex locator, drill, cleaner, scraper, filler, hardener, or other medical devices. The devices may be powered through a cord or may be cordless and are capable of being activated and deactivated. In some cases, the devices may require a warm up period after activation before they are ready for use. While embodiments of the invention are described herein in the context of dental and endodontic applications, it should be appreciated that aspects of the invention may prove beneficial over a broader range of medical procedures utilizing a plurality of electrical/powered devices or instruments. Accordingly, the present invention should not be necessarily limited to applications in the dental or endodontic fields.

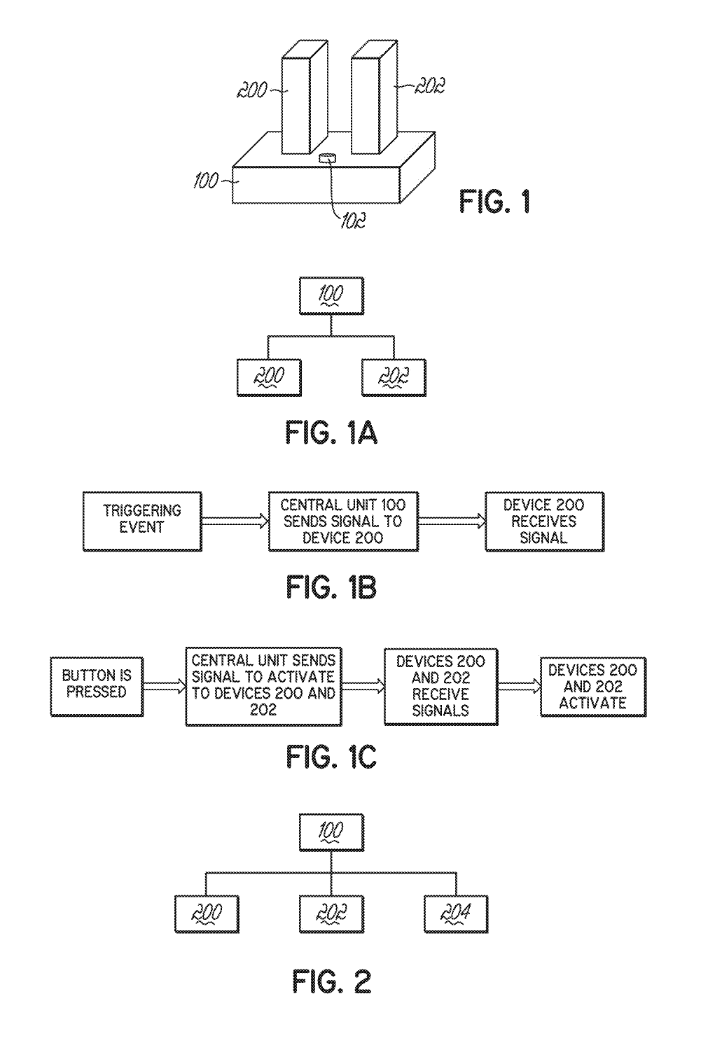

FIG. 1 illustrates an embodiment of the present invention where devices 200 and 202 are received on central unit 100. Central unit 100 is configured to receive devices 200 and 202, where, for example, central unit 100 acts as a base or cradle for the devices. For example, central unit 100 may have a protrusion that fits into a recess in devices 200 and 202, securing devices 200 and 202 to central unit 100. Central unit 100 may further be configured to charge the devices. In the present embodiment, central unit 100 has a button 102. Among other things, central unit 100 may also have a display, indicator, retinal scanner, or audio receiver. In this embodiment, central unit 100 is configured to communicate with devices 200 and 202. FIG. 1A is a graphical illustration of the embodiment in FIG. 1 where central unit 100 is in communication with devices 200 and 202. The communication between the central unit and devices may be accomplished using mechanical means, electrical means, wired communication, or wireless communication, such as Bluetooth or other known protocol.

FIG. 1B illustrates a sequence of events when a triggering event occurs in the embodiment illustrated in FIG. 1. When button 102 is pressed by a clinician, for example, a triggering event has occurred. The triggering event causes central unit 100 to send device 200 a signal to activate. Device 200 receives the signal from central unit 100 and then activates as a result of receiving the signal. The signal to a device may be a signal to activate or to deactivate.

FIG. 1C illustrates an alternate sequence of events when a triggering event occurs in the embodiment illustrated in FIG. 1. When button 102 is pressed, the triggering event causes central unit 100 to send a signal to activate simultaneously to both devices 200 and 202. Devices 200 and 202 receive the signals and both then activate. In an alternate embodiment of the present invention, pressing the button 102 on the central unit 100 may result in all devices connected to the central unit being deactivated. This deactivation may occur simultaneously, for example.

A wide variety of events may act as a triggering event. For example, the triggering event may be the activation or deactivation of a device. For example, when a first device is activated, a second device may also activate. Alternatively, when a first device is deactivated, a second device is activated. In alternate embodiments, the triggering event may occur based on a device reaching a certain output. For example, the triggering event may occur when a drill motor reaches a certain speed. In further alternate embodiments, the triggering event may be the lapse of a predetermined amount of time. Thus, for example, after a first device has been activated for a predetermined amount of time, a second device may be activated. The triggering event may also occur upon a voice command being spoken or sufficient eye contact being made with a retinal scanner. If the central unit is configured to receive the devices as illustrated in FIG. 1, a triggering event could be, for example, replacing the first device on the central unit or picking up the next device to be used. In alternate embodiments, the triggering event may occur when a device is put down on a flat surface or in a charging cradle. In addition to the embodiment illustrated in FIG. 1, a button, which creates a triggering event when pressed, may be on a device. In other embodiments, the triggering event may be based on data output from the environment or patient monitoring. For example, this may include temperature thresholds, humidity, light level or intensity, cardio monitor, oxygen sensor, combinations thereof, and other environmental indicators and patient sensors. Further, the triggering event may include a combination of events. For example, a triggering event may occur when a device has been activated for 5 minutes and the device reaches a certain output, such as the motor reaching 500 rpm. The triggering event may also occur upon the earliest or latest occurrence of multiple events. For example, the triggering event may occur at the earliest of a lapse of 5 minutes or the time when the device motor reaches a certain speed. As this non-inclusive list of examples shows, triggering events may be manual or automatic. For example, pressing a button is manual, and the lapse of a predetermined time is automatic.

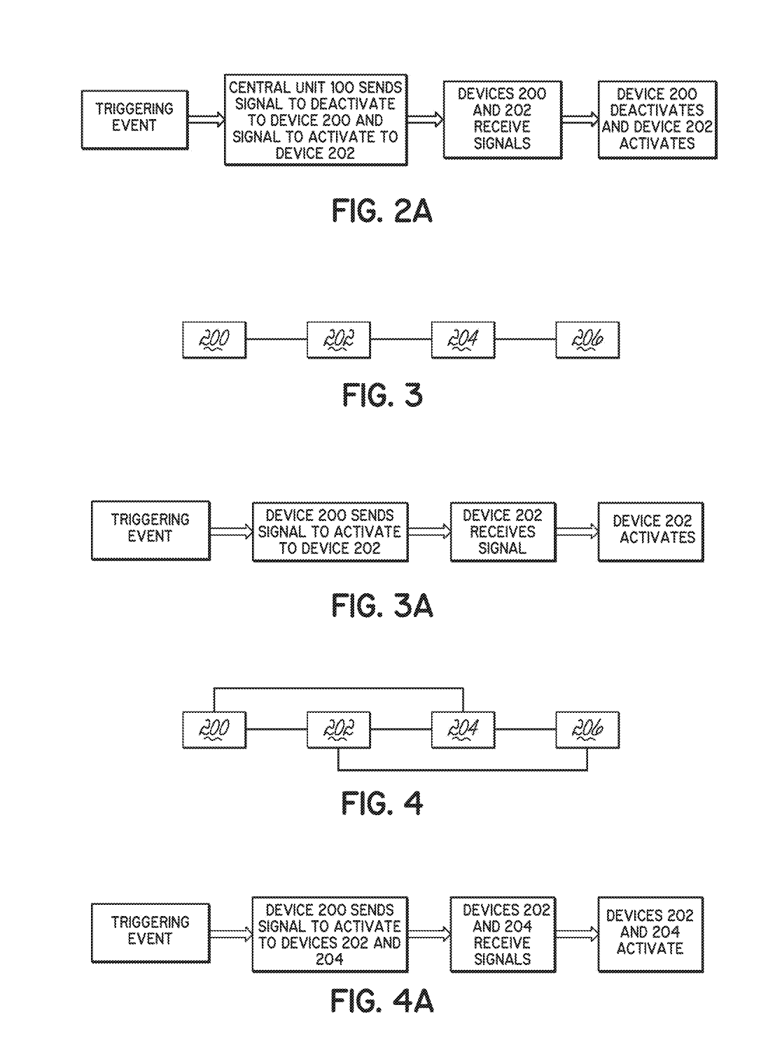

In some embodiments of the present invention, one triggering event results in a variety of signals being sent to more than one device. FIG. 2 is a graphical illustration of central unit 100 that is in communication with devices 200, 202, and 204, and FIG. 2A illustrates a sequence of events when a triggering event occurs in the embodiment illustrated in FIG. 2. When a triggering event occurs, central unit 100 sends a signal to deactivate to device 200, which had been previously activated (not shown). At the same time, central unit 100 sends device 202 a signal to activate. In an alternate embodiment, the triggering event may cause the central unit to send a signal to deactivate to device 200 and a signal to activate to devices 202 and 204. This may be useful where a clinician wants to begin using device 202 before device 204, but device 204 needs time to warm up before use.

The devices used in the present invention may have an order of use in any given procedure. For example, in a root canal procedure, a pulp scanner may be used before a drill. Further, the number of devices may vary based on the procedure being performed. Though some embodiments of the present invention are illustrated using a specific number of devices, embodiments of the present invention are not limited to any certain number of devices. Because the number and order of devices used in dental procedures varies, a triggering event schedule may be utilized. The particular signal sent due to the occurrence of a triggering event may be determined based on the schedule. The complexity of the schedule may vary. In such an embodiment, the first triggering event may activate only a first device or more than just the first device, as illustrated in FIGS. 1B and 1C. Similarly, a later triggering event may activate or deactivate multiple devices, as illustrated in FIG. 2A. The triggering event schedule may include triggering events that are manual and/or automatic. By way of example, an exemplary embodiment of the present invention may have the first triggering event in the schedule be pressing a button while all subsequent triggering events are based on lengths of elapsed time. For example, the first triggering event activates the first device, the second triggering event occurs five minutes later and causes the second device to activate, and the third triggering event occurs after five more minutes causing the third device to activate. Further, the passage of an hour may be a triggering event resulting in all devices being deactivated.

Certain embodiments of the present invention include a device capable of communicating with another device. FIG. 3 is a graphical illustration of devices 200, 202, 204, and 206 where each device is in communication with at least one of the other devices. FIG. 3A illustrates a sequence of events when a triggering event occurs in the embodiment illustrated in FIG. 3. In this regard, when a triggering event occurs, device 200 sends a signal to activate to device 202. Device 202 receives the signal and activates. For example, the triggering event in this embodiment could be pressing a power switch (not shown) on device 200. Like the central unit, the devices may also have a display, indicator, retinal scanner, or audio receiver.

In certain embodiments of the present invention, a device may be in communication with more than one other device. FIG. 4 is a graphical illustration of devices 200, 202, 204, and 206 where each device is in communication with at least two of the other devices. FIG. 4A illustrates a sequence of events when a triggering event occurs in the embodiment illustrated in FIG. 4. When a triggering event occurs, device 200 sends a signal to activate to both device 202 and 204. Devices 202 and 204 receive the signals and activate. In an alternate embodiment, a triggering event signals device 200 to deactivate, device 202 to deactivate, and device 204 to activate. An example of when this may be useful is where a clinician begins using device 202 but may require the use of device 200 during the use of device 202. In this example, once the clinician is finished with device 202, the clinician may press a power switch on device 202 deactivating both devices 200 and 202 and activating device 204.

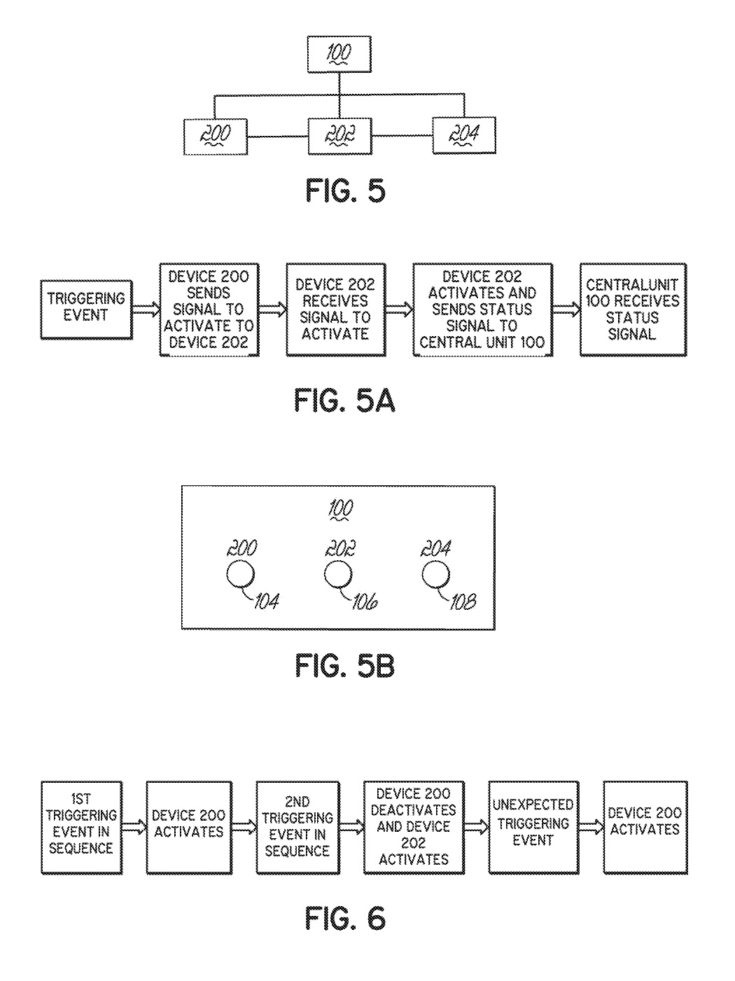

In certain embodiments of the present invention, a device may be in communication with a central unit and at least one other device. FIG. 5 is a graphical illustration of devices 200, 202, and 204 where each device is in communication with central unit 100 and at least one of the other devices. In addition to the types of signals discussed above, a triggering event may result in a signal of the current status of a device to be sent, such as a signal that the device is activated. Central unit 100 may be configured to indicate or display the current status of any devices in communication with the central unit. FIG. 5A illustrates a sequence of events when a triggering event occurs in the embodiment illustrated in FIG. 5. When a triggering event occurs, device 200 sends a signal to activate to device 202. Device 202 receives the signal to activate, activates, and then sends a status signal to central unit 100. Central unit 100 receives the status signal. Central unit 100 may then indicate that device 202 is activated. FIG. 5B is an elevation view of central unit 100 depicted in FIG. 5 where central unit 100 is configured to indicate the status of each of the devices with which it is in communication. Indicator lights 104, 106, and 108 may, for example, use a green light to indicate a device is activated and a red light to indicate a device is deactivated. In alternate embodiments, the central unit may indicate the status of the devices using a display or using audio signals for when a device activates and deactivates.

In certain embodiments of the present invention, a triggering event may result in the triggering event schedule being overridden. FIG. 6 illustrates a sequence of events when a triggering event results in an override of the schedule. In the embodiment, a schedule may include a sequence of triggering events and a related sequence of signals to send. When the first triggering event in the sequence occurs, device 200 activates. When the second triggering event in the sequence occurs, device 200 deactivates and device 202 activates. When an unexpected triggering event occurs, the schedule is overridden and device 200 activates. This may be useful where a clinician unexpectedly needs a device to complete a step in the procedure that is normally not needed. In alternate embodiments of the present invention, the override of the schedule may affect the whole schedule, rather than just affecting the status of one device. For example, the clinician may press a button placing the schedule on hold. This may be useful if the clinician knows, for example, that shaping the canal will take longer than usual and the clinician doesn't want the next triggering event to occur before that step is completed.

As stated above, the communication between the central unit and/or the devices may be accomplished using mechanical means, electrical means, wired communication, or wireless communication. The communication between the central unit and/or the devices may be accomplished using a controller. The controller may be separate from the devices and central unit or it may be integral to a device or the central unit. The controller may include a processor, a memory, a mass storage memory device, an input/output (I/O) interface, and a Human Machine Interface (HMI). The controller may also be operatively coupled to one or more external resources via a network or I/O interface. External resources may include, but are not limited to, servers, databases, mass storage devices, peripheral devices, cloud-based network services, or any other suitable computer resource that may used by the controller.

The processor may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on operational instructions that are stored in the memory. The memory may include a single memory device or a plurality of memory devices including, but not limited, to read-only memory (ROM), random access memory (RAM), volatile memory, non-volatile memory, static random access memory (SRAM), dynamic random access memory (DRAM), flash memory, cache memory, or any other device capable of storing information. The mass storage memory device may include data storage devices such as a hard drive, optical drive, tape drive, non-volatile solid state device, or any other device capable of storing information. The processor may operate under the control of an operating system that resides in the memory. The operating system may manage computer resources so that computer program code embodied as one or more computer software applications, such as an application residing in the memory, may have instructions executed by the processor. In an alternative embodiment, the processor may execute the application directly, in which case the operating system may be omitted. One or more data structures may also reside in the memory and may be used by the processor, operating system, or application to store or manipulate data.

The I/O interface may provide a machine interface that operatively couples the processor to other devices and systems, such as a network or external resource. The application may thereby work cooperatively with the network or external resource by communicating via the I/O interface to provide the various features, functions, applications, processes, or modules comprising embodiments of the invention. The application may also have program code that is executed by one or more external resources, or otherwise rely on functions or signals provided by other system or network components external to the controller. Indeed, given the nearly endless hardware and software configurations possible, persons having ordinary skill in the art will understand that embodiments of the invention may include applications that are located externally to the controller, distributed among multiple computers or other external resources, or provided by computing resources (hardware and software) that are provided as a service over the network, such as a cloud computing service.

The terminology used herein is for the purpose of describing particular embodiments only and is not intended to be limiting of the embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising”.

While all of the invention has been illustrated by a description of various embodiments and while these embodiments have been described in considerable detail, it is not the intention of the Applicants to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicants' general inventive concept.

What is claimed is:

1. An apparatus for powering medical devices on and off, the apparatus comprising:
a plurality of medical devices, each of the plurality of medical devices configured to be electrically activated and deactivated; and
a central unit configured to communicate with each of the plurality of medical devices and to receive a signal indicative of a triggering event;
wherein, responsive to receiving a signal that a first triggering event has occurred, the central unit sends each of the plurality of medical devices a signal to activate at the same time.

2. The apparatus of claim 1, wherein, responsive to receiving a signal that a second triggering event has occurred, the central unit sends each of the plurality of medical devices a signal to deactivate at the same time.

3. An apparatus for powering medical devices on and off, the apparatus comprising:
one or more medical devices, each of the one or more medical devices configured to be electrically activated and deactivated; and
a central unit configured to receive a signal indicative of a triggering event, to communicate with each of the one or more medical devices, and to send a signal to at least one of the one or more medical devices when a triggering event occurs.

4. The apparatus of claim 3, further comprising at least two medical devices and wherein each of the at least two medical devices is configured to communicate with at least one other of the at least two medical devices.

5. The apparatus of claim 4, wherein each of the at least two medical devices is configured to communicate with all of the other at least two medical devices.

6. The apparatus of claim 3, further comprising at least two medical devices and the central unit is configured to send a signal the at least two medical devices when a triggering event occurs.

7. The apparatus of claim 6, wherein the signal is at least one selected from the group consisting of a signal to activate and a signal to deactivate.

8. The apparatus of claim 3, wherein the signal is chosen based on a schedule of triggering events.

9. The apparatus of claim 8, wherein the schedule of triggering events includes triggering events that are at least one selected from the group consisting of manual and automatic.

10. The apparatus of claim 3, wherein the triggering event comprises a button being pressed, a voice command, an output of a retinal scanner, a lapse of a predetermined length of time, a predetermined output by one of the medical devices, a deactivation of one of the medical devices, the activation of one of the medical devices, or a combination of these events.

11. The apparatus of claim 3, wherein the central unit is configured to receive the at least one of the one or more medical devices on the central unit.

12. The apparatus of claim 11, wherein the central unit is configured to charge the at least one of the one or more medical devices when the at least one of the one or more medical devices is received on the central unit.

13. The apparatus of claim 3, wherein the central unit indicates a status of each of the one or more medical devices and the status comprises one selected from the group consisting of an activated state and a deactivated state.

14. An apparatus for powering medical devices on and off, the apparatus comprising:
at least two medical devices, each of the at least two medical devices configured to be electrically activated and deactivated and to communicate with at least one other of the at least two medical devices;
wherein at least one of the at least two medical devices is configured to sense a triggering event and to send a signal to at least one other medical device of the at least two medical devices when the triggering event occurs.

15. The apparatus of claim 14, wherein each medical device is capable of communicating with all of the other at least two medical devices.

16. The apparatus of claim 15, wherein the signal is sent to the at least two medical devices when a triggering event occurs.

17. The apparatus of claim 16, wherein the signal is chosen based on a schedule of triggering events.

18. The apparatus of claim 17, further comprising a central unit configured to communicate with the at least two medical devices.

19. The apparatus of claim 18, wherein communication between the at least two medical devices and the central unit is a signal of a status of each of the at least two medical devices, where the status comprises an activated state and a deactivated state.

20. The apparatus of claim 19, wherein the central unit is configured to indicate the status of each of the at least two medical devices.

21. The apparatus of claim 20, wherein the central unit is configured to receive the at least two medical devices on the central unit.

22. The apparatus of claim 21, wherein the central unit is configured to charge the at least two medical devices when the at least two medical devices are received on the central unit.

23. A method of powering medical devices on and off, the method comprising:
communicatively connecting a plurality of medical devices to a central unit, wherein
each medical device is capable of being activated and deactivated; and
upon an occurrence of a first triggering event, sending a signal from the central unit to each of the plurality of medical devices to activate at the same time, whereby the plurality of medical devices activate.

24. The method of claim 23, further comprising, upon an occurrence of a second triggering event, sending a signal from the central unit to each of the plurality of medical devices to deactivate at the same time.

25. The method of claim 24, further comprising receiving the plurality of medical devices on the central unit.

26. The method of claim 25, further comprising charging the plurality of medical devices received on the central unit.

27. The method of claim 23, wherein sending a signal includes sending a signal to activate from the central unit to at least one of the plurality of medical devices and sending a signal to deactivate from the central unit to at least one other of the plurality of medical devices.

28. A method of powering medical devices on and off, the method comprising:
communicatively connecting at least two medical devices, wherein each of the at least two medical devices is capable of being electrically activated and deactivated; and
upon an occurrence of a triggering event, sending a signal selected from the group consisting of a signal to activate and a signal to deactivate from one of the at least two medical devices to at least one of the other at least two medical devices.

29. The method of claim 28, further comprising:
communicatively connecting the at least two medical devices to a central unit, and
upon an occurrence of a triggering event, sending a signal from at least one of the at least two medical devices to the central unit.

30. The method of claim 29, further comprising receiving the at least two medical devices on the central unit.

31. The method of claim 30, further comprising charging the at least two medical devices received on the central unit.
